(19) United States
(12) Patent Application Publication
(10) Pub. No.: US 2001/0006895 A1
(43) Pub. Date: Jul. 5, 2001

(54) Method of establishing tandem free operation mode in a cellular mobile telephone network

(76) Inventor: Fabrice Della Mea, Paris (FR)

Correspondence Address: SUGHRUE, MION, ZINN, MACPEAK & SEAS, PLLC, Suite 800, 2100 Pennsylvania Avenue, N.W., Washington, DC, 20037-3213, US

(21) Appl. No.: 09/749,656

(22) Filed: Dec. 28, 2000

(30) Foreign Application Priority Data
Dec. 31, 1999 (FR) 99 16 822.

(51) Int. Cl. H04Q 7/20

(52) U.S. Cl. 455/453; 455/560; 455/403

(57) ABSTRACT

A method of establishing the tandem free operation mode for a mobile station to mobile station and cell to cell call in a cellular mobile telephone system, which method includes a step of selecting a common coding mode for each mobile station and the selection of a common coding mode takes account of the traffic load in at least one cell.

The present invention relates generally to cellular mobile telephone systems.

The present invention relates more particularly to voice services and the techniques employed in cellular mobile telephone systems to optimize the quality of service.

### BACKGROUND OF THE INVENTION

As a general rule, various coding modes can be used to transmit voice over the radio interface, corresponding to different compromises between voice quality and the radio resources needed to transmit voice. In the Global System for Mobile station communications (GSM), the following coding modes can be used, among others:

full rate (FR) mode, corresponding to a bit rate of 13 kbit/s,

enhanced full rate (EFR) mode, corresponding to a bit rate of 12.2 kbit/s, and

half-rate (HR) mode, corresponding to a bit rate of 5.6 kbit/s.

The HR mode therefore consumes the least resources; it requires only one half of a time slot, rather than the one time slot required by the FR mode. The HR mode therefore offers increased capacity compared to the FR or the EFR mode; on the other hand, the quality obtained with the HR mode is generally lower than that obtained with the FR or the EFR mode, in particular in the case of poor transmission conditions.

As a general rule, a coding mode matching requirements can be chosen for a given mobile station as a function of predetermined criteria and in a fixed or adaptive manner. Selection is made from amongst the coding modes supported by the mobile station (i.e. the codes supported by the mobile station and by the entities of the system handling a call for the mobile station, as will be assumed throughout the remainder of the description).

Equipment units referred to as transcoders are used to convert from the coding mode used for transmission over the radio interface to a standard coding mode such as PCM (Pulse Code Modulation) mode, generally used in fixed or “wired” networks and corresponding to a bit rate of 64 kbit/s. In GSM, a transcoder of the above kind is also referred to as a Transcoder Rate Adaptor Unit (TRAU).

Although this transcoding is actually needed for a call between a mobile terminal and a fixed terminal, it is not needed for a call between two mobile terminals. In the latter case, to avoid unnecessary degradation of the voice by submitting it to two successive transcoding operations unnecessarily, an operating mode can be used that is referred to herein as Tandem Free Operation (TFO). A TFO mode is specified in GSM Recommendations 02.53, 03.53 and 08.62 in particular.

Establishing TFO mode generally requires a dialogue or exchange of signaling between like entities of the system handling the call for each mobile station concerned. One object of the exchange of signaling is to be sure that both transcoders are capable of operating in TFO mode. Also, because coding mode is generally selected independently for each mobile station concerned, another object of the exchange of signaling is to have a common coding mode selected for TFO mode, and so a change of coding mode may be required for at least one of the mobile stations if the coding mode currently selected for that mobile station is not the common coding mode selected for use in TFO mode.

The criterion for selecting a common coding mode is conventionally a quality optimization criterion, which conforms to the objective for TFO mode.

The Applicant has noted that in some cases a quality optimization criterion can degrade system performance, as will now be explained with reference to an example shown in FIG. 1.

Consider the case of a call between two mobile stations in two separate cells A and B. The entities of the system handling the call for each mobile station are respectively:

base station subsystems BSSA and BSSB (which include the base transceiver station (BTS) and base station controller (BSC) entities) for functions relating to transmission over the radio interface), and

transcoders TCA and TCB for the transcoding function.

Consider further the case of a busy cell A and a cell B that is not busy when the coding mode initially selected for the mobile station in cell A is HR mode and the coding mode initially selected for the mobile station in cell B is FR or EFR mode, for example EFR mode.

Consider further the situation in which each mobile station supports all of the coding modes, namely the HR, FR and EFR modes.

During a first step 1, using specific signaling techniques that are not described here, each BSS communicates to the associated TC the coding mode initially selected for the mobile station concerned and a list of the coding modes supported by that mobile station.

During a second step 2, also using specific signaling techniques that are not described here, each TC communicates information to the other TC.

If, as in this example, the coding modes initially selected independently for each mobile station concerned are different (which situation is referred to by the expression “codec mismatch” in the GSM recommendations previously referred to), during a third step 3 each of the transcoders selects a common coding mode for TFO mode on the basis of the lists of supported coding modes corresponding to each mobile station and as a function of the same criterion.

Because the criterion conventionally used for selecting the common coding mode is a quality optimization criterion, as previously mentioned, if either FR mode or EFR mode is supported in common, it is selected as the common mode for TFO mode.

Accordingly, in this example, and as shown by means of corresponding tables in FIG. 1, the common coding mode selected in step 3 is EFR mode (which was selected initially for the mobile station in cell B).

During a fourth step 4, each BSS is informed by the associated TC of the common coding mode selected in this way for TFO mode.

Using techniques known in the art and not described here, the coding mode is then changed from HR mode to EFR mode for the mobile station in cell A.

With the stated hypothesis of a cell A that is already busy, the above approach merely increases the load on the cell, and in particular the rejected call rate. This degrades system performance instead of achieving the improvement expected of TFO mode.

### OBJECTS AND SUMMARY OF THE INVENTION

An object of the invention is to avoid such drawbacks as much as possible whilst retaining the advantages of TFO mode.

The present invention therefore provides a method of establishing the tandem free operation mode for a mobile station to mobile station and cell to cell call in a cellular mobile telephone system, which method includes a step of selecting a common coding mode for each mobile station and the selection of a common coding mode takes account of the traffic load in at least one cell.

According to another feature, said common coding mode is selected on the basis of lists of coding modes supported by each mobile station and if the corresponding mobile station is in a busy cell the list of supported coding modes is shortened to eliminate therefrom the coding modes that consume the most resources.

According to another feature, a common coding mode is selected on the basis of non-shortened lists of supported coding modes if no common coding mode can be selected on the basis of lists of supported coding modes at least one of which is a shortened list.

According to another feature, the criterion for selecting a common coding mode on the basis of lists of coding modes supported by each mobile station is a quality optimization criterion.

According to another feature, common coding modes for each mobile station are initially selected independently of each other and a list of supported coding modes is shortened only if the coding mode initially selected for the corresponding mobile station is additionally one of the coding modes consuming the least resources.

According to another feature, coding modes for each mobile station are initially selected independently of each other, the method further determines if the coding modes initially selected for each mobile station are identical, and:

if they are identical, the corresponding coding mode constitutes said common coding mode, or

if they are not identical, said common coding mode is selected on the basis of said lists of supported coding modes for each mobile station.

According to another feature, the method includes at least one step during which an entity of said system handling the call for each mobile station communicates a list of supported coding modes for that mobile station to a like entity handling the call for the other mobile station and a subsequent step during which each entity selects a common coding mode on the basis of lists of supported coding modes for each mobile station and in accordance with the same criterion.

According to another feature, the method includes a step during which an entity of said system handling the call for each mobile station communicates the coding mode initially selected for that mobile station to a like entity handling the call for the other mobile station and a subsequent step during which each entity determines if the coding modes initially selected for each mobile station are identical.

According to another feature, said system is GSM.

According to another feature, one of said coding modes consuming the least resources is half-rate mode.

According to another feature, one of said coding modes consuming the most resources is full-rate mode.

According to another feature, one of said coding modes consuming the most resources is enhanced full-rate mode.

The present invention also provides a cellular mobile telephone system for implementing a method of the above kind, which system therefore essentially includes, for establishing the tandem free operation mode for a mobile station to mobile station and cell to cell call, means for selecting a common coding mode for each mobile station taking account of the traffic load in at least one cell.

### BRIEF DESCRIPTION OF THE DRAWINGS

Other objects and features of the present invention will become apparent on reading the following description, which is given with reference to the accompanying drawings, in which:

FIG. 1 shows one example of a conventional process for establishing TFO mode,

FIG. 2 shows, by way of example, a first embodiment of a method in accordance with the invention for establishing TFO mode, and

FIG. 3 shows, by way of an example, a second embodiment of a method in accordance with the invention for establishing TFO mode.

### MORE DETAILED DESCRIPTION

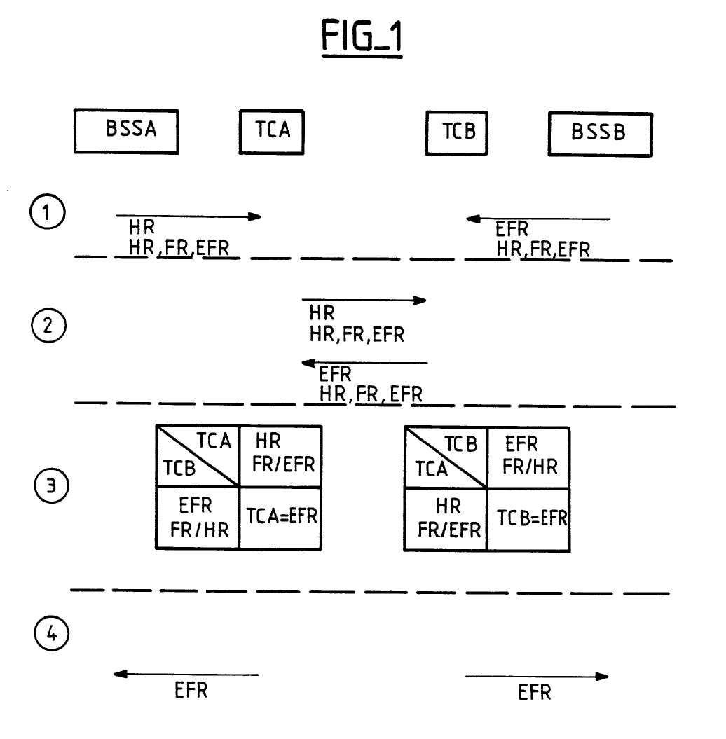

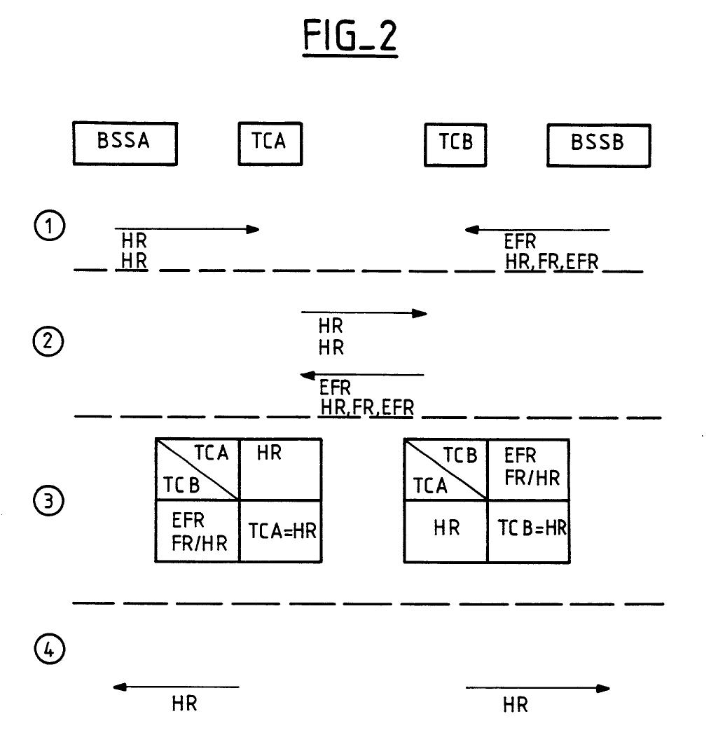

As in FIG. 1, and again by way of example, FIG. 2 covers the situation of a busy cell A and a cell B that is not busy when the coding mode initially selected for the mobile station in cell A is HR mode, the coding mode initially selected for the mobile station in cell B is EFR mode, and the HR, FR, and EFR coding modes are all supported by each mobile station concerned.

In this example, using the method shown in FIG. 2, each BSS starts by determining if the coding mode initially selected for the mobile station concerned is HR mode and if the corresponding cell is busy. A cell can typically be considered to be busy if the quantity of resources allocated in that cell during a given period is greater than a given threshold.

If the above two conditions are satisfied (which is the case for cell A in this example), the list of the supported coding modes is shortened to eliminate the FR and EFR coding modes (the modes which consume the most resources), and therefore to retain only HR mode.

If the above two conditions are not satisfied (which is the case for cell B in this example), the list of the coding modes supported is not shortened, and therefore includes all supported coding modes, namely the HR, FR, and EFR modes in this example.

Thus in this example the method shown in FIG. 2 includes:

a step 1′ during which, using specific signaling techniques not described here, each BSS communicates to the associated TC the coding mode initially selected for the mobile station concerned and the list of supported coding modes obtained in this way,

a step 2′ during which, also using specific signaling techniques not described here, each TC communicates the above information to the other TC,

a step 3′ in which, because the coding modes initially selected for each mobile station are different, each TC selects a common coding mode for TFO mode from the lists of supported coding modes obtained in this way and as a function of a common criterion, and

a step 4′ during which each TC informs the associated BSS of the common coding mode selected for the TFO mode.

Thus in this example the common coding mode selected for TFO mode in step 3′ is HR mode. Consequently, and in contrast to FIG. 1, the mobile station in cell A retains the HR mode initially selected but the coding mode is changed from FR mode to HR mode for the mobile station in cell B.

It is thus apparent that the method shown in FIG. 2 avoids the disadvantages previously mentioned of the method shown in FIG. 1 and therefore improves system performance overall.

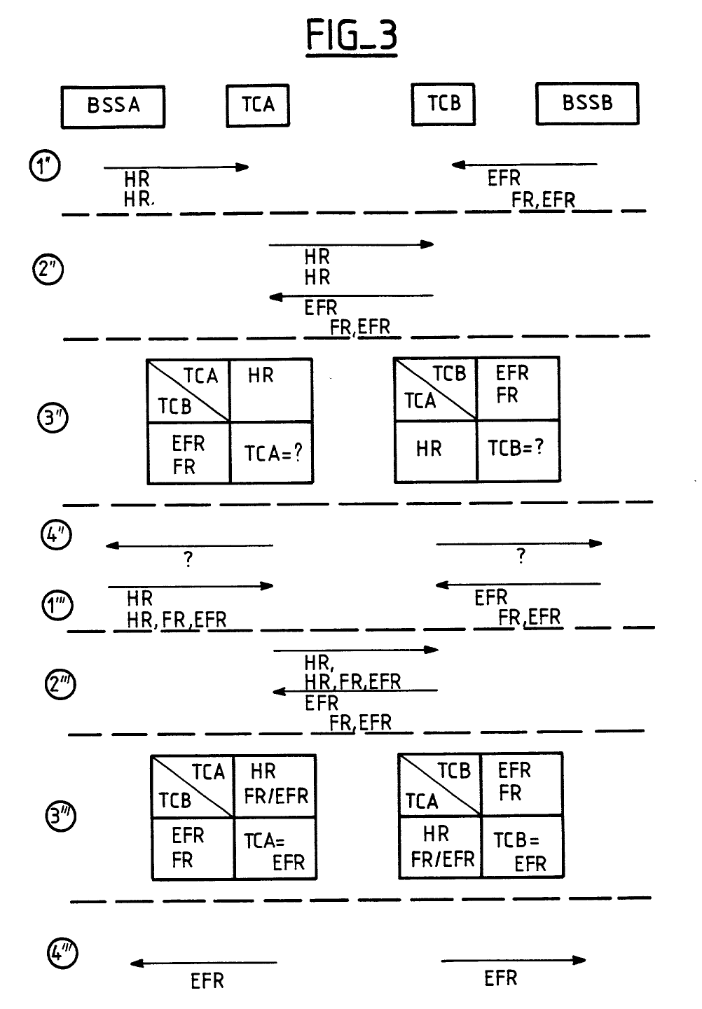

However, in this example, the FIG. 2 embodiment presupposes that HR mode is also supported by the mobile station in the cell that is not busy (cell B in this instance). The FIG. 3 embodiment provides a solution if that assumption is false.

As in FIGS. 1 and 2, and again by way of example, FIG. 3 considers the case of a busy cell A and a cell B that is not busy when the coding mode initially selected for the mobile station in cell A is HR mode and the coding mode initially selected for the mobile station in cell B is EFR mode.

FIG. 3 also addresses the situation in which the mobile station in cell A supports all of the HR, FR, and EFR coding modes, and the situation in which the mobile station in cell B supports only the FR and EFR modes.

Initially a method similar to that shown in FIG. 2 is adopted, the corresponding steps being here denoted 1″, 2″, 3″ and 4″. As in FIG. 2, the list of coding modes supported by the mobile station in cell A is a shortened list (in this instance containing only HR mode) and the list of coding modes supported by the mobile station in cell B is a non-shortened list (in this instance comprising both the FR and the EFR modes). As shown by corresponding tables in FIG. 3, no common coding mode can then be selected on the basis of such lists of coding modes, as indicated in FIG. 3 by the symbol “?”. In this case, if nothing were done, the operating mode would then be tandem mode.

To avoid tandem mode, in a second time period, and on detection of the results obtained after steps 1″ to 4″, a method similar to that shown in FIG. 1 can be adopted, the corresponding steps being here denoted 1″″″, 2″″″, 3″″″ and 4″″″ (note that the exchanges of signaling between BSSB and TCB during steps 4″ and 1″″, as shown in FIG. 3, might be omitted). The list of coding modes supported by the mobile station in cell A is then a non-shortened list (in this instance comprising the HR, FR and EFR modes) and the list of coding modes supported by the mobile station in cell B is still a non-shortened list (in this instance comprising the FR and EFR modes). As shown by means of corresponding tables in FIG. 3, the common coding mode selected in step 3″″″ is EFR mode (the mode initially selected for the mobile station in cell B).

Accordingly, in this embodiment, if no common coding mode can be selected on the basis of the lists of coding modes, at least one of which is a shortened list, then a common coding mode is selected on the basis of non-shortened lists. This provides for less strict observance of the traffic load in the busy cell, beginning by giving preference to establishing TFO mode with a mode consuming less resources and then, if this is not possible, accepting that it is necessary to establish it with a mode consuming more resources.

To complete the methods described above, if necessary, when the coding mode initially selected for a mobile station in a busy cell is not HR mode, but is either FR mode or EFR mode, the method could be a conventional method as shown in FIG. 1.

Moreover, the situation in which the same coding mode is initially selected for each mobile station (which is referred to by the expression “codecs match” in the GSM recommendations previously referred to) could be handled in the conventional way, the coding mode concerned then constituting the common coding mode searched for, without it being necessary to provide a specific step for selecting the common coding mode.

The method of the invention could however be used in the situation where, although the coding mode initially selected for each mobile station is HR mode, a specific common coding mode selection step is additionally provided, based on the lists of supported coding modes and on a quality optimization criterion.

Note that FIGS. 1 to 3 shows such methods only diagrammatically, at the level required to understand the present invention, and without entering into the detail of the signaling protocols or methods, which can employ principles that are the norm in such systems.

Note also that the figures correspond to one particular example, and to one particular system, in this instance GSM, but that the invention is not limited to any such example and/or any such system.

In particular:

the HR coding mode, on the one hand, and the FR and EFR coding modes, on the other hand, are merely examples of coding modes which respectively consume less and more resources,

the like entities which communicate the list of supported coding modes to each other and which select a common coding mode on that basis could be entities other than transcoders, and

the common coding mode could also be selected in a centralized manner in the same entity, rather than separately and as a function of the same criterion in two separate like entities,

The present invention also provides, over and above a method of the above kind, a cellular mobile telephone system including means for implementing the method of the invention.

In this example, the system would include means for executing the steps previously described.

More generally, a system according to the invention essentially includes, for establishing the TFO mode for a mobile station to mobile station and cell to cell call, means for selecting a common coding mode for each mobile station allowing for the traffic load of at least one of said cells.

Because the particular implementation of such means will be obvious to the skilled person, such means do not need to be described here in more detail than by stating their function, as previously.

1. A method of establishing the tandem free operation mode for a mobile station to mobile station and cell to cell call in a cellular mobile telephone system, which method includes a step of selecting a common coding mode for each mobile station and the selection of a common coding mode takes account of the traffic load in at least one cell.

2. A method according to claim 1, wherein said common coding mode is selected on the basis of lists of coding modes supported by each mobile station and if the corresponding mobile station is in a busy cell the list of supported coding modes is shortened to eliminate therefrom the coding modes that consume the most resources.

3. A method according to claim 2, wherein a common coding mode is selected on the basis of non-shortened lists of supported coding modes if no common coding mode can be selected on the basis of lists of supported coding modes at least one of which is a shortened list.

4. A method according to claim 3, wherein the criterion for selecting a common coding mode on the basis of lists of coding modes supported by each mobile station is a quality optimization criterion.

5. A method according to claim 2, wherein common coding modes for each mobile station are initially selected independently of each other and a list of supported coding modes is shortened only if the coding mode initially selected for the corresponding mobile station is additionally one of the coding modes consuming the least resources.

6. A method according to claim 2, wherein coding modes for each mobile station are initially selected independently of each other, the method further determines if the coding modes initially selected for each mobile station are identical, and:
if they are identical, the corresponding coding mode constitutes said common coding mode, or
if they are not identical, said common coding mode is selected on the basis of said lists of supported coding modes for each mobile station.

7. A method according to claim 2, including at least one step during which an entity of said system handling the call for each mobile station communicates a list of supported coding modes for that mobile station to a like entity handling the call for the other mobile station and a subsequent step during which each entity selects a common coding mode on the basis of lists of supported coding modes for each mobile station and as a function of the same criterion.

8. A method according to claim 6, including at least one step during which an entity of said system handling the call for each mobile station communicates a list of supported coding modes for that mobile station to a like entity handling the call for the other mobile station and a subsequent step during which each entity selects a common coding mode on the basis of lists of supported coding modes for each mobile station and as a function of the same criterion, and determines if the coding modes initially selected for each mobile station are identical.

9. A method according to claim 1, wherein said system is GSM.

10. A method according to claim 1, wherein one of said coding modes consuming the least resources is half-rate mode.

11. A method according to claim 1, wherein one of said coding modes consuming the most resources is full-rate mode.

12. A method according to claim 1, wherein one of said coding modes consuming the most resources is enhanced full-rate mode.

13. A cellular mobile telephone system for implementing a method according to claim 1, the system including, for establishing the tandem free operation mode for a mobile station to mobile station and cell to cell call, means for selecting a common coding mode for each mobile station taking account of the traffic load in at least one cell.
